(19) United States
(12) Patent Application Publication
(10) Pub. No.: US 2025/0158768 A1
(43) Pub. Date: May 15, 2025

(54) INFORMATION TRANSCEIVING METHOD AND APPARATUS

(71) Applicant: FUJITSU LIMITED, Kawasaki-shi (JP)

(72) Inventors: Gang SUN, Beijing (CN); Xin WANG, Beijing (CN)

(73) Assignee: FUJITSU LIMITED, Kawasaki-shi (JP)

(21) Appl. No.: 19/024,369

(22) Filed: Jan. 16, 2025

Related U.S. Application Data
(63) Continuation of application No. PCT/CN2022/110977, filed on Aug. 8, 2022.

(51) Int. Cl. H04L 5/00; H04B 7/06; H04L 27/26

(52) U.S. Cl. CPC H04L 5/0048; H04B 7/0626; H04L 27/261

(57) ABSTRACT

An information transceiving method and apparatus. The method includes: transmitting request indication information for acquiring a first reference signal set by a terminal equipment to a network device; and receiving a first reference signal in the first reference signal set transmitted by the network device; or, transmitting third resource configuration information by a network device to a terminal equipment, the third resource configuration information including a reference signal set identifier and identifiers of reference signals in the reference signal set; transmitting first reference signal set indication information to the terminal equipment; and transmitting a first reference signal in the first reference signal set to the terminal equipment.

### CROSS-REFERENCE TO RELATED APPLICATION

This application is a continuation application of International Application PCT/CN2022/110977 filed on Aug. 8, 2022, and designated the U.S., the entire contents of which are incorporated herein by reference.

### TECHNICAL FIELD

This disclosure relates to the field of communication technologies.

### BACKGROUND

As low-frequency spectrum resources become scarce, millimeter wave bands are able to provide greater bandwidths and have become important frequency bands for 5G NR (New Radio) systems. As millimeter waves are relatively short in wavelengths and have propagation characteristics different from conventional low-frequency bands, such as higher propagation loss, and poor reflection and diffraction performances, etc., larger scale of antenna arrays are usually used to form a shaped beam with greater gains, overcome propagation losses, and ensure system coverage. 5G NR standards have designed a series of solutions for beam management, including beam scanning, beam measurement, beam report, and beam indication, etc. However, when the number of receiving and transmitting beams is relatively large, the payload and latency of the system are greatly increased.

With the development of artificial intelligence (AI) technologies, applying the AI technologies to physical layers of wireless communication to solve difficulties of conventional methods has become a current technological direction. For beam management, using AI models to predict a spatially optimal beam pair according to results of measurement of a small number of beams may significantly reduce the payload and latency of the system.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

Assuming that a transmitter end of a communication system has M beams and a receiver end thereof has N beams, in existing standards, it is needed to measure M*N beams. When the numbers of M and N are relatively large, measuring M*N beams results in a relatively large system payload and relatively long latency. Using models (such as AI models) to predict an optimal beam pair with results of measurement of a small number of beams may greatly reduce the system payload and latency caused by the beam measurement.

It was found by the inventors that if an AI model is deployed at a terminal equipment side, in a stage of training the AI model, a network device configures a reference signal set for beam measurement, transmits reference signals in the reference signal set to the terminal equipment via different transmitting beams for beam measurement, and takes results of measurement as label data for AI model training. In a stage of inference by using the trained AI model, the AI model only needs to partially results of measurement of the transmitting beams, that is, the terminal equipment needs only to receive a part of the reference signals in the reference signal set. However, as the AI model is deployed at the terminal equipment side, the terminal equipment knows information on the part of reference signals needed by the AI model, but the network device does not know the information on the part of reference signals. Currently, there is no solution for how the terminal equipment informs the network device of the information on the part of reference signals.

It was found by the inventors that if the AI model is deployed at the network device side, in the stage of training the AI model, the network device configures the reference signal set for beam measurement, transmits the reference signals in the reference signal set to the terminal equipment via different transmitting beams for beam measurement, and the terminal equipment reports the results of measurement to the network device for being taken as label data for AI model training. In the stage of inference by using the trained AI model, the network device needs only to configure a part of reference signals in the reference signal set and transmits them to the terminal equipment via a part of transmitting beams for beam measurement and report. Information reported by the terminal equipment needs to include the information on the part of the reference signals; however, there is currently no solution for how the network device informs the terminal equipment of the information on the part of reference signals.

In order to solve at least one of the above problems, embodiments of this disclosure provide an information transceiving method and apparatus.

According to one aspect of the embodiments of this disclosure, there is provided an information transceiving apparatus, applicable to a terminal equipment, the apparatus including:
a first transmitting unit configured to transmit request indication information for acquiring a first reference signal set to a network device; and
a first receiving unit configured to receive a first reference signal in the first reference signal set transmitted by the network device.

According to another aspect of the embodiments of this disclosure, there is provided an information transceiving apparatus, applicable to a network device, the apparatus including:
a second receiving unit configured to receive request indication information transmitted by a terminal equipment for acquiring a first reference signal set; and
a second transmitting unit configured to transmit a first reference signal in the first reference signal set to the terminal equipment.

According to a further aspect of the embodiments of this disclosure, there is provided an information transceiving apparatus, applicable to a network device, the apparatus including:
a third transmitting unit configured to transmit third resource configuration information to a terminal equipment, the third resource configuration information including a reference signal set identifier and identifiers of reference signals in the reference signal set;
a fourth transmitting unit configured to transmit first reference signal set indication information to the terminal equipment; and
a fifth transmitting unit configured to transmit a first reference signal in the first reference signal set to the terminal equipment.

According to still another aspect of the embodiments of this disclosure, there is provided an information transceiving apparatus, applicable to a terminal equipment, the apparatus including:
a fourth receiving unit configured to receive third resource configuration information transmitted by a network device, the third resource configuration information including a reference signal set identifier and identifiers of reference signals in the reference signal set;
a fifth receiving unit configured to receive first reference signal set indication information transmitted by the network device; and
a sixth receiving unit configured to receive a first reference signal in the first reference signal set transmitted by the network device.

An advantage of the embodiments of this disclosure exists in that the terminal equipment transmits the request indication information for acquiring the part of reference signals to the network device, thereby informing the network device of the information on the part of reference signals used in the stage of inference of the AI model, which may effectively use the AI model to predict the optimal beam pair, and greatly reduce the system payload and latency caused by beam measurement.

Another advantage of the embodiments of this disclosure exists in that the network device transmits the indication information on the part of reference signals to the terminal equipment, thereby informing the terminal equipment of the information on the part of reference signals used in the stage of inference of the AI model, which may effectively use the AI model to predict the optimal beam pair, and greatly reduce the system payload and latency caused by beam measurement.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/comprising/including/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiments of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of a communication system of embodiments of this disclosure;

FIG. 2 is a schematic diagram of a transmitting beam and a receiving beam in the communication system of embodiments of this disclosure;

FIG. 3 is a schematic diagram of an information transceiving method of embodiments of this disclosure;

FIG. 4 is a schematic diagram of transmitting beams and receiving beams of embodiments of this disclosure;

FIGS. 5-7 are schematic diagrams of request indication information of embodiments of this disclosure;

FIGS. 8A and 8B are exemplary diagrams of request indication information of the embodiments of this disclosure;

FIG. 9 is a schematic diagram of an information transceiving method of embodiments of this disclosure;

FIG. 10 is a schematic diagram of an information transceiving method of embodiments of this disclosure;

FIG. 11 is a schematic diagram of an information transceiving method of embodiments of this disclosure;

FIG. 12 is a schematic diagram of an information transceiving method of embodiments of this disclosure;

FIG. 13 is a schematic diagram of an information transceiving method of embodiments of this disclosure;

FIG. 14 is a schematic diagram of an information transceiving method of embodiments of this disclosure;

FIG. 15 is a schematic diagram of an information transceiving method of embodiments of this disclosure;

FIG. 16 is a schematic diagram of an information transceiving apparatus of embodiments of this disclosure;

FIG. 17 is a schematic diagram of an information transceiving apparatus of embodiments of this disclosure;

FIG. 18 is a schematic diagram of an information transceiving apparatus of embodiments of this disclosure;

FIG. 19 is a schematic diagram of an information transceiving apparatus of embodiments of this disclosure;

FIG. 20 is a schematic diagram of a network device of embodiments of this disclosure; and

FIG. 21 is a schematic diagram of a terminal equipment of embodiments of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, 5G, new radio (NR) and 6G in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, an industrial wireless device, a surveillance camera, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” may refer to a network device, and may also refer to a terminal equipment, except otherwise specified.

In the following description, without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable.

The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable.

In addition, transmitting or receiving a PUSCH may be understood as transmitting or receiving uplink data carried by the PUSCH, transmitting or receiving a PUCCH may be understood as transmitting or receiving uplink information carried by the PUCCH, transmitting or receiving a PRACH may be understood as transmitting or receiving a preamble carried by the PRACH. The uplink signal may include an uplink data signal and/or an uplink control signal, etc., and may be referred to as uplink transmission or uplink information or an uplink channel. Transmitting uplink transmission on an uplink resource may be understood as transmitting the uplink transmission by using the uplink resource. Likewise, downlink data/signal/channel/information may be understood correspondingly.

In the embodiments of this disclosure, higher-layer signaling may be, for example, radio resource control (RRC) signaling; for example, it is referred to an RRC message, which includes an MIB, system information, and a dedicated RRC message; or, it is referred to an as an RRC information element (RRC IE). Higher-layer signaling may also be, for example, medium access control (MAC) signaling, or an MAC control element (MAC CE); however, this disclosure is not limited thereto.

Scenarios in the embodiments of this disclosure shall be described below by way of examples; however, this disclosure is not limited thereto.

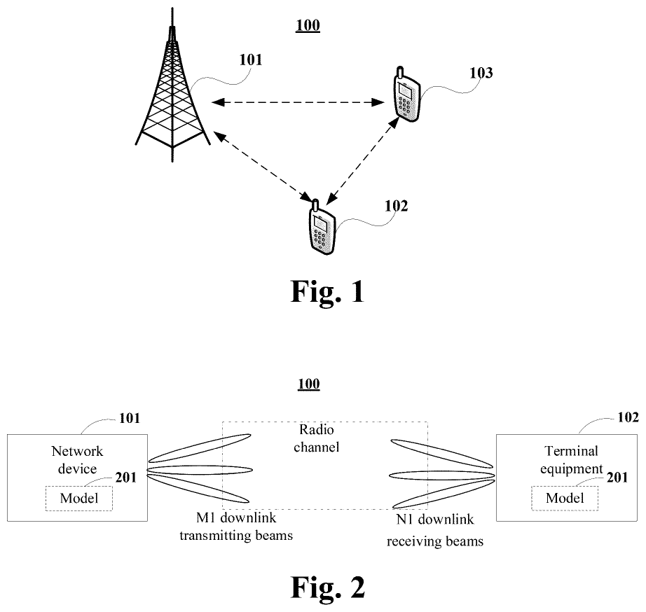

FIG. 1 is a schematic diagram of a communication system of embodiments of this disclosure, in which a case where terminal equipments and a network device are taken as examples is schematically shown. As shown in FIG. 1, a communication system 100 may include a network device 101 and terminal equipments 102, 103. For the sake of simplicity, an example having only two terminal equipments and one network device is schematically given in FIG. 1; however, the embodiments of this disclosure is not limited thereto.

In the embodiments of this disclosure, existing services or services that may be implemented in the future may be performed between the network device 101 and the terminal equipments 102, 103. For example, such services may include but not limited to an enhanced mobile broadband (eMBB), massive machine type communication (mMTC), and ultra-reliable and low-latency communication (URLLC), etc.

The terminal equipment 102 may transmit data to the network device 101, such as in a granted or grant-free transmission manner. The network device 101 may receive data transmitted by one or more terminal equipments 102 and feed back information to the terminal equipment 102, such as acknowledgement (ACK)/non-acknowledgement (NACK) information. According to the feedback information, the terminal equipment 102 may acknowledge end of a transmission process, or may perform new data transmission, or may perform data retransmission.

It should be noted that FIG. 1 shows that two terminal equipments 102, 103 are both in coverage of the network device 101. However, this disclosure is not limited thereto, and the two terminal equipments 102, 103 may not be in coverage of the network device 101, or one terminal equipment 102 is in coverage of the network device 101 and the other terminal equipment 103 is out of coverage of the network device 101.

An AI model (or an ML model) includes but are not limited to an input layer (input), multiple convolutional layers, a concatenation layer (concat), a fully connected layer (FC), and a quantizer, etc., and processing results of the multiple convolutional layers are merged in the concatenation layer. Reference may be made to existing techniques for a specific structure of the AI model, which shall not be repeated herein any further.

FIG. 2 is a schematic diagram of a transmitting beam and a receiving beam in the communication system of the embodiments of this disclosure. As shown in FIG. 2, in the communication system 100, taking a downlink channel as an example, the network device 101 may have M1 downlink transmitting beams DL TX, and the terminal equipment 102 may have N1 downlink receiving beams DL RX.

In the embodiment of this disclosure, as shown in FIG. 2, a model 201 for predicting a beam measurement result may be deployed in the network device 101 or the terminal equipment 102.

The model 201 may predict measurement results of M1*N1 beams according to measurement results of a part of beams. The model 201 may be, for example, an AI model, and the model 201 may be deployed in the network device 101 or the terminal equipment 102.

In addition, for an uplink channel, the network device 101 may have N2 uplink receiving beams (not shown in FIG. 2), and the terminal equipment 102 may have M2 uplink transmitting beams UL TX (not shown in FIG. 2).

In order to solve the above problems, embodiments of this disclosure provide an information transceiving method and apparatus, which shall be described below with reference to the accompanying drawings and embodiments.

### Embodiments of a First Aspect

The embodiments of this disclosure provide an information transceiving method, which shall be described from a terminal equipment side, an AI model being deployed at the terminal equipment side.

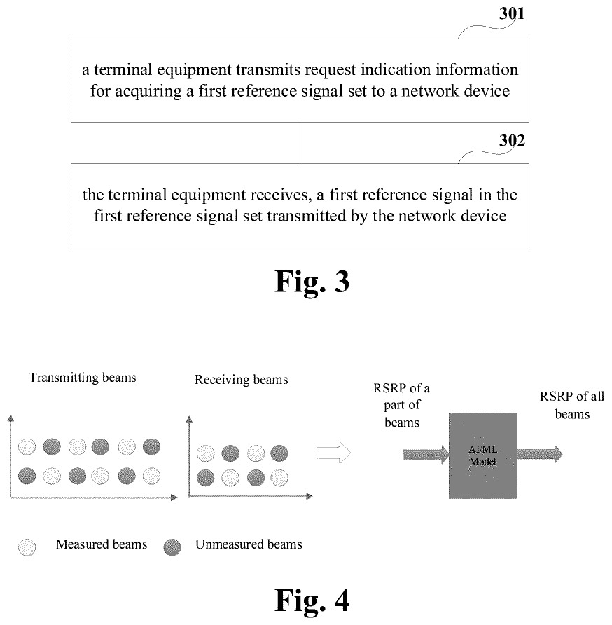

FIG. 3 is a schematic diagram of the information transceiving method of the embodiments of this disclosure. As shown in FIG. 3, the method includes:
301: the terminal equipment transmits request indication information for acquiring a first reference signal set to a network device; and
302: the terminal equipment receives, a first reference signal in the first reference signal set transmitted by the network device.

It should be noted that FIG. 3 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 3.

In some embodiments, the AI model for beam prediction is deployed in the terminal equipment, and an optimal beam pair is predicted by using the AI model according to measurement results of a small number of beam pairs. Input parameters of the AI model are RSRP (reference signal receiving power) values of a part of beam pairs, and may also be SINR (signal to interference plus noise ratio) values of a part of beam pairs, and physical quantities of output parameters are RSRP or SINRs of all beam pairs. FIG. 4 is a schematic diagram of the transmitting beams, receiving beams and AI model in the embodiments of this disclosure. As shown in FIG. 4, for example, there are 12 downlink transmitting beams, 8 downlink receiving beams and total 96 beam pairs. Through configuration, the UE only measures RSRP of 24 beam pairs (6 downlink transmitting beams and 4 downlink receiving beams). At this moment, a dimension of the input parameters of the AI model is 24, a physical quantity thereof is RSRP or an SINR, and a dimension of the output parameters is 96, a physical quantity thereof is also RSRP or an SINR, and the optimal beam pair may be selected from results of prediction.

That is, in an inference stage of the AI model, measurement results of all transmitting beams are not needed, only measurement results of a part of transmitting beams are needed, and the terminal equipment only needs to receive reference signals transmitted by the part of transmitting beams (also referred to as a part of reference signals or first reference signals) to perform beam measurement, thereby obtaining results of prediction. As the AI model is deployed at the terminal equipment side, the network device does not know which part of reference signals that are needed by the AI model at the terminal equipment side. Therefore, in the embodiments of this disclosure, the terminal equipment may transmit the request indication information for obtaining the first reference signal set to the network device.

With the above embodiment, the terminal equipment transmits the request indication information for obtaining the part of reference signals to the network device, thereby informing the network device of information on the part of reference signals in the inference stage of the AI model. Hence, the AI model may be effectively used to predict an optimal beam pair, which may greatly reduce a system payload and latency caused by the beam measurement.

Detailed description shall be given below, in which a reference signal and a measurement resource or a resource are interchangeable.

In some embodiments, the network device configures measurement resources (reference signals) for downlink transmitting beams via first resource configuration information. The measurement resources (reference signals) may be CSI-RSs and/or SSBs, etc., for example, the configured measurement resources are resource set lists (reference signal sets), each resource set consisting of one or more measurement resources (reference signals). In other words, the network device may configure multiple reference signals used for beam measurement for the terminal equipment. The first resource configuration information includes a reference signal set identifier (measurement resource set identifier) and an identifier/identifiers of one or more measurement resources (reference signals) constituting the reference signal set (measurement resource set).

For example, when the reference signals are CSI-RSs, the first resource configuration information may be non-zero power CSI-RS resource set configuration information, and NZP-CSI-RS-ResourceSet may be expressed as follows by using an ASN.1 data format:

-- ASN1START
-- TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-RS- |

ResourcesPerSet)) OF NZP-CSI-RS-ResourceId,

| | |
|---|---|
| repetition | ENUMERATED { on, off } |
| OPTIONAL, | |
| aperiodicTriggeringOffset | INTEGER(0..6) |
| OPTIONAL, | |
| trs-Info | ENUMERATED {true} |
| OPTIONAL, | |
| ..., | |
| [[ | |
| aperiodic TriggeringOffset-r16 | INTEGER(0..31) |
| OPTIONAL - | |
| ]] | |

}
-- TAG-NZP-CSI-RS-RESOURCESET-STOP
-- ASN1STOP

That is, nzp-CSI-ResourceSetId denotes the reference signal set identifier, and SEQUENCE (SIZE (1 . . . maxNrofNZP-CSI-RS-ResourcesPerSet)) OF NZP-CSI-RS-ResourceId denotes identifiers of reference signals in the reference signal set.

For example, when the reference signals are SSBs, the first resource configuration information may be CSI-SSB-ResourceSet, which may be expressed as follows by using an ASN.1 data format:

-- ASN1START
-- TAG-CSI-SSB-RESOURCESET-START

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB-ResourcePerSet)) |

OF SSB-Index,
...
}
-- TAG-CSI-SSB-RESOURCESET-STOP
-- ASN1STOP

That is, csi-SSB-ResourceSetId denotes the reference signal set identifier, and SEQUENCE (SIZE(1 . . . maxNrofCSI-SSB-ResourcePerSet)) OF SSB-Index denotes identifiers of reference signals in the reference signal set.

In some embodiments, the first resource configuration information is carried by RRC signaling, the reference signal set configured thereby may also be understood as a complete set of reference signals used for beam measurement, and a training stage of the AI model needs results of measurement performed by all reference signals in the reference signal set.

In some embodiments, in 301, the request indication information for obtaining a first reference signal set is transmitted to the network device. A first reference signal in the first reference signal set is one or more reference signals in the reference signal set, and the first reference signal set may also be referred to as a reference signal subset. The terminal equipment may select one or more reference signals from the reference signal set as demanded by the AI model and takes the one or more reference signals as the first reference signal set, and transmit the request indication information for obtaining the first reference signal set to the network device.

In some embodiments, the request indication information includes an identifier of the first reference signal in the first reference signal set, or the request indication information indicates the first reference signal set in the configured reference signal set in a manner of a bitmap or a starting position and interval information. The request indication information may be carried by RRC or an MAC CE or UCI.

Following are respective descriptions.

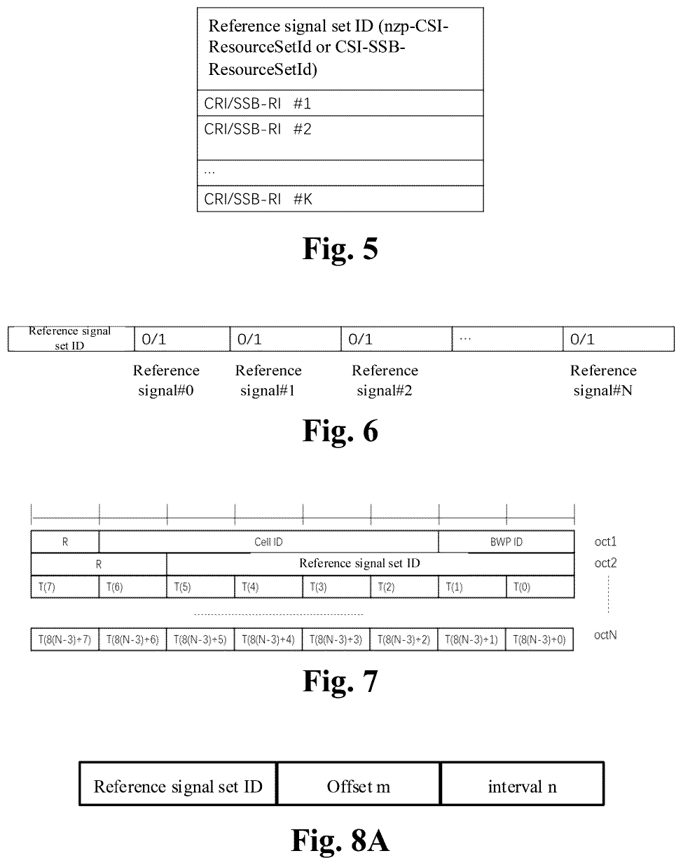

For example, the request indication information includes the identifier of the first reference signal in the first reference signal set, the identifier of the first reference signal being CRI or an SSB-RI, and the request indication information may further include an identifier of the reference signal set, the identifier of the reference signal set being nzp-CSI-RS-ResourceSetId or CSI-SSB-ResourceSetId. FIG. 5 is an exemplary diagram of the request indication information. As shown in FIG. 5, the identifier of the reference signal set included in the request indication information is nzp-CSI-RS-ResourceSetId or CSI-SSB-ResourceSetId, and identifiers of K first reference signals in the first reference signal set are CRI/SSB-RI #1, CRI/SSB-RI #2, . . . , CRI/SSB-RI #K, and the request indication information gives the identifiers of the first reference signals in a form of a list. In this embodiment, the request indication information may be newly-added RRC signaling or existing RRC signaling or a newly-added information element in UCI, and the embodiments of this disclosure are not limited thereto.

For example, the request indication information indicates the first reference signal set in the configured reference signal set in a manner of a bitmap. The number of bits in the bitmap may be determined according to the number of reference signals in the reference signal set, each bit corresponding to a reference signal in the reference signal set, and a value of the bit being used to indicate whether a corresponding reference signal is a first reference signal (or being used to indicate whether the first reference signal set includes a reference signal to which the bit corresponds). For example, when a value of the bit is 0, it indicates that the reference signal is not a first reference signal and is not included in the first reference signal set, and when a value of the bit is 1, it indicates that the reference signal is a first reference signal and is included in the first reference signal set, and vice versa. The request indication information may further include a reference signal set identifier, which is nzp-CSI-RS-ResourceSetId or CSI-SSB-ResourceSetId. FIG. 6 is an exemplary diagram of the request indication information. As shown in FIG. 6, the request indication information includes a reference signal set identifier (ID) nzp-CSI-RS-ResourceSetId or CSI-SSB-ResourceSetId. A reference signal set to which the reference signal set identifier corresponds has N reference signals. The request indication information further includes N bits, which correspond sequentially to a reference signal #0, a reference signal #1 . . . , a reference signal #N in the reference signal set. For example, N=8 and the bitmap is 10000110, then reference signals #0, #5 and #6 in the reference signal set are the first reference signals and are included in the first reference signal set; or, the bitmap is 10000110 indicates that the first reference signals in the first reference signal set include reference signals #0, #5 and #6 in the reference signal set. In this embodiment, the request indication information may be newly-added RRC signaling or existing RRC signaling or a newly-added information element in UCI, and the embodiments of this disclosure are not limited thereto. For example, the request indication information may also be newly-added MAC CE signaling, and may further include a cell ID and/or a bandwidth part (BWP) ID, etc. FIG. 7 is an exemplary diagram of the request indication information. As shown in FIG. 7, the request indication information includes a cell identifier, a BWP identifier, a reference signal set identifier (e.g. 6 bits) and a bit T (k) indicating whether each reference signal in the reference signal set is the first reference signal. If a value of T (k) is 0, it indicates that a reference signal to which T (k) corresponds is not a first reference signal; and if it is 1, it indicates that the corresponding reference signal is a first reference signal, and all first reference signals constitute the first reference signal set. For example, the number of reference signals in the reference signal set is 64, the value of N is 10, and the value of k is 0-63.

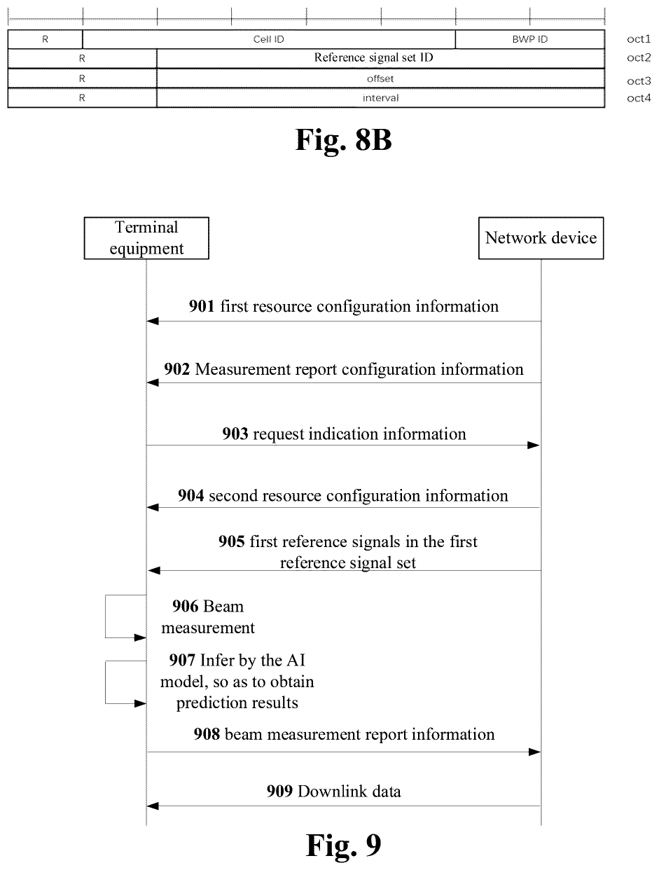

For example, the request indication information indicates the first reference signal set in the configured reference signal set in a manner of a starting position and interval information. The starting position offset denotes an index position of a reference signal in the reference signal set that is first indicated as a first reference signal, and the interval information interval denotes an interval between indices of the first reference signals in the reference signal set, that is, they indicate starting positions and intervals of indices of the first reference signal set in the reference signal set. The request indication information may further include a reference signal set identifier, which is nzp-CSI-RS-ResourceSetId or CSI-SSB-ResourceSetId. FIG. 8A is an exemplary diagram of the request indication information. As shown in FIG. 8A, the identifier of the reference signal set included in the request indication information is nzp-CSI-RS-ResourceSetId or CSI-SSB-ResourceSetId, and there are to N=64 reference signals in the reference signal set to which the reference signal set identifier corresponds. The request indication information further includes a starting position offset m of 2 and an interval information interval n of 8. Therefore, reference signals in the reference signal set with indices #2, #10, #18, #26, #34, #42, #42, #50 and #58 are first reference signals, or reference signals in the reference signal set with indices #2, #10, #18, #26, #34, #42, #50 and #58 constitute the first reference signal set. In this embodiment, the request indication information may be newly-added RRC signaling or existing RRC signaling or an information element newly-added in UCI; however, the embodiments of this disclosure are not limited thereto. For example, the request indication information may also be newly-added MAC CE signaling, and may further include a cell identifier and/or a bandwidth part (BWP) identifier, etc. FIG. 8B is an exemplary diagram of the request indication information. As shown in FIG. 8B, the request indication information includes a cell identifier, a BWP identifier, a reference signal set identifier (e.g. 6 bits), a starting position offset and interval information interval. For example, the number of reference signals in the reference signal set is 64, and values of the starting position offset and interval information interval are 0-63, which may also be denoted by 6 bits.

In some embodiments, after receiving the request indication information, the network device may directly transmit the first reference signals in the first reference signal set indicated by the request indication information, or may transmit second resource configuration information before transmitting the first reference signals in the first reference signal set. The second resource configuration information includes identification indication information of the first reference signals in the first reference signal set, and optionally, it may further include the identifier of the first reference signal set and/or the identifier of the reference signal set in the first resource configuration information to which the first reference signal set corresponds, wherein the second resource configuration information may be newly-added signaling, and may be transmitted separately from the first resource configuration information, which shall be described below respectively by way of examples.

In some embodiments, when the second resource configuration information is newly-added signaling, implementation of the second resource configuration information is similar to that of the first resource configuration information. For example, the reference signal set identifier in the first resource configuration information is replaced with the first reference signal set identifier, and identifiers of reference signals in the reference signal set are replaced with identifiers of first reference signals in the first reference signal set (taken as the identifier indication information of the first reference signals); or, the identifier indication information of the first reference signals in the second resource configuration information indicates the first reference signals in the configured reference signal set in a manner of a bitmap or a starting position and interval information. The second resource configuration information is carried by RRC signaling, which shall be described below by way of examples.

For example, when the reference signal is a CSI-RS, the first resource configuration information may be non-zero power CSI-RS resource set configuration information, and the newly-added second resource configuration information NZP-CSI-RS-ResourceSubSet may be expressed as follows by using an ASN.1 data format:

-- ASN1START
-- TAG-NZP-CSI-RS-RESOURCESUBSET-START

| | |
|---|---|
| NZP-CSI-RS-ResourceSubSet ::= | SEQUENCE { |
| nzp-CSI-ResourceSubSetId | NZP-CSI-RS-ResourceSubSetId, |
| nzp-CSI-ResourceSetId | NZP-CSI-RS-ResourceSetId, |
| nzp-CSI-RS-Resources-subset | BIT STRING (size(maxNrofNZP-CSI-RS- |

ResourcesPerSet))
}
-- TAG-NZP-CSI-RS-RESOURCESUBSET-STOP

As shown above, information elements of the second resource configuration information NZP-CSI-RS-ResourceSubSet may include identifier nzp-CSI-ResourceSubSetId of the first reference signal set, the identifier nzp-CSI-ResourceSetId of the reference signal set in the first resource configuration information to which the first reference signal set corresponds and the identification indication information nzp-CSI-RS-Resources-subset of the first reference signals in the first reference signal set, wherein the identification indication information nzp-CSI-RS-Resources-subset of the first reference signals in the first reference signal set is indicated by a bitmap of the reference signal set to which the first reference signals correspond, and has a length maxNrofNZP-CSI-RS-ResourcesPerSet. That each bit value in the bitmap is 0 indicates that a reference signal to which the bit corresponds is not included in the first reference signal set, and that a bit value is 1 indicates that a reference signal to which the bit corresponds is included in the first reference signal set, and vice versa. It should be noted that other configuration information of the first reference signal set, such as repetition, and aperiodicTriggeringOffset, etc., may be defaulted to be consistent with configuration of the reference signal set in the first resource configuration information to which the first reference signal set corresponds, that is, configuration of a corresponding information element in the first resource configuration information may be reused, and no additional configuration is needed.

For another example, when the reference signal is a CSI-RS, the first resource configuration information may be non-zero power CSI-RS resource set configuration information, and the newly-added second resource configuration information NZP-CSI-RS-ResourceSubSet may be expressed as follows by using an ASN.1 data format:

-- ASN1START
-- TAG-NZP-CSI-RS-RESOURCESUBSET-START

| | |
|---|---|
| NZP-CSI-RS-ResourceSubSet ::= | SEQUENCE { |
| nzp-CSI-ResourceSubSetId | NZP-CSI-RS-ResourceSubSetId, |
| nzp-CSI-ResourceSetId | NZP-CSI-RS-ResourceSetId, |
| nzp-CSI-RS-Resources-subset | SEQUENCE { |
| offset | INTEGER(0.. maxNrofNZP-CSI-RS-ResourcesPerSet-1) |
| interval | INTEGER(1.. maxNrofNZP-CSI-RS-ResourcesPerSet-1) |

}
}
-- TAG-NZP-CSI-RS-RESOURCESUBSET-STOP

That is, the information elements of the second resource configuration information NZP-CSI-RS-ResourceSubSet may include identifier nzp-CSI-ResourceSubSetId of the first reference signal set, the identifier nzp-CSI-ResourceSetId of the reference signal set in the first resource configuration information to which the first reference signal set corresponds and the identification indication information nzp-CSI-RS-Resources-subset of the first reference signals in the first reference signal set, wherein the identification indication information of the first reference signals in the first reference signal set is indicated by an offset field and an interval field of the first reference signals to which the reference signal set corresponds, which are respectively used to indicate a starting position and interval of the index of the first reference signal set in the reference signal set. It should be noted that the offset field and interval field are integers, and ranges thereof are determined according to maxNrofNZP-CSI-RS-ResourcesPerSet. It should be also noted here that data types of the offset and interval are defined by using continuous integers, and other data types may also be adopted, such as enumeration, and the embodiments of this disclosure are not limited thereto. It should be further noted that other configuration information of the first reference signal set, such as repetition, and aperiodicTriggeringOffset, etc., may be defaulted to be consistent with configuration of the reference signal set in the first resource configuration information to which the first reference signal set corresponds, that is, configuration of a corresponding information element in the first resource configuration information may be reused, and no additional configuration is needed.

For example, when the reference signal is an SSB, the first resource configuration information may be CSI-SSB-ResourceSet, and the newly-added second resource configuration information CSI-SSB-ResourceSubSet may be expressed as follows by using an ASN.1 data format:

-- ASN1START
-- TAG-CSI-SSB-RESOURCESUBSET-START

| | |
|---|---|
| CSI-SSB-ResourceSubSet ::= | SEQUENCE { |
| csi-SSB-ResourceSubSetId | CSI-SSB-ResourceSubSetId, |
| csi-SSB-ResourceSetId | CSI-SSB-ResourceSetId, |
| csi-SSB-Resources-subset | BIT STRING (size(maxNrofCSI-SSB-ResourcePerSet)) |

}
-- TAG-CSI-SSB-RESOURCESUBSET-STOP
-- ASN1STOP

That is, information elements of the second resource configuration information CSI-SSB-ResourceSubSet may include the identifier csi-SSB-ResourceSubSetId of the first reference signal set, the identifier csi-SSB-ResourceSetId of the reference signal set in the first resource configuration information to which the first reference signal set corresponds and the identifier indication information csi-SSB-Resources-subset of the first reference signals in the first reference signal set, wherein the identification indication information of the first reference signals in the first reference signal set is indicated by a bitmap of the first reference signal corresponding to the reference signal set, and has a length maxNrofCSI-SSB-ResourcesPerSet. That each bit value in the bitmap is 0 indicates that a reference signal to which the bit corresponds is not included in the first reference signal set, and that a bit value is 1 indicates that a reference signal to which the bit corresponds is included in the first reference signal set, and vice versa. It should be noted that other configuration information of the first reference signal set may be defaulted to be consistent with configuration of the reference signal set in the first resource configuration information to which the first reference signal set corresponds, that is, configuration of a corresponding information element in the first resource configuration information may be reused, and no additional configuration is needed.

For example, when the reference signal is an SSB, the first resource configuration information may be CSI-SSB-ResourceSet, and the newly-added second resource configuration information CSI-SSB-ResourceSubSet may be expressed as follows by using an ASN.1 data format:

-- ASN1START
-- TAG-CSI-SSB-RESOURCESUBSET-START

| | |
|---|---|
| CSI-SSB-ResourceSubSet ::= | SEQUENCE { |
| csi-SSB-ResourceSubSetId | CSI-SSB-ResourceSubSetId, |
| csi-SSB-ResourceSetId | CSI-SSB-ResourceSetId, |
| csi-SSB-Resources-subset | SEQUENCE { |
| offset | INTEGER(0.. maxNrofCSI-SSB-ResourcePerSet -1) |
| interval | INTEGER(1.. maxNrofCSI-SSB-ResourcePerSet -1) |

}
-- TAG-CSI-SSB-RESOURCESUBSET-STOP
-- ASN1STOP

That is, information elements of the second resource configuration information CSI-SSB-ResourceSubSet may include the identifier csi-SSB-ResourceSubSetId of the first reference signal set, the identifier csi-SSB-ResourceSetId of the reference signal set in the first resource configuration information to which the first reference signal set corresponds and the identification indication information csi-SSB-Resources-subset of the first reference signals in the first reference signal set, wherein the identification indication information of the first reference signals in the first reference signal set is indicated by an offset field and an interval field of the first reference signals to which the reference signal set corresponds, which are respectively used to indicate a starting position and interval of the index of the first reference signal set in the reference signal set. It should be noted that the offset field and interval field are integers, and a range thereof is determined according to maxNrofCSI-SSB-ResourcesPerSet. It should be also noted here that data types of the offset and interval are defined by using continuous integers, and other data types may also be adopted, such as enumeration, and the embodiments of this disclosure are not limited thereto. It should be further noted that other configuration information of the first reference signal set may be defaulted to be consistent with configuration of the reference signal set in the first resource configuration information to which the first reference signal set corresponds, that is, configuration of a corresponding information element in the first resource configuration information may be reused, and no additional configuration is needed.

In some embodiments, when the second resource configuration information is newly-added signaling, it may also be implemented by MAC CE signaling. For example, after the RRC signaling configures the first resource configuration information, an MAC CE is used to activate/deactivate the reference signals in the reference signal set, so as to indirectly indicate resource configuration of the first reference signals in the first reference signal set. A method for activating/deactivating the reference signals in the reference signal set by the MAC CE signaling may be indicating by a bitmap or a starting position and interval information. For example, the bitmap or starting position and interval information indicate(s) whether each reference signal in the reference signal set is activated or deactivated, that is, the bitmap or starting position and interval information indicate(s) the activated reference signals in the reference signal set, and the activated reference signals are taken as the first reference signals in the first reference signal set. Implementation thereof is similar to that of the request indication information MAC CE signaling, which shall not be repeated herein any further.

It should be noted that names of the above fields are examples only, and the embodiments of this disclosure are not limited thereto.

In some embodiments, the request indication information is transmitted after the first resource configuration information (excluding the second resource configuration information) but before the second resource configuration information.

In some embodiments, in 302, the network device transmits the first reference signals on downlink channels based on the first resource configuration information and the request indication information or based on the second resource configuration information. That is, the terminal equipment receives corresponding first reference signals on corresponding time-frequency resources according to mapped time-frequency resources, and periods, etc., of the first reference signals configured in the resource configuration information, and performs beam measurement on the first reference signals in the first reference signal set, results of the beam measurement being used for inference of the AI model.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

With the above embodiment, the terminal equipment transmits the request indication information for acquiring the part of reference signals to the network device, thereby informing the network device of the information on the part of reference signals used in the stage of inference of the AI model, which may effectively use the AI model to predict the optimal beam pair, and greatly reduce the system payload and latency caused by beam measurement.

### Embodiments of a Second Aspect

The embodiments of this disclosure provide an information transceiving method, which shall be described from a network device side, an AI model being deployed at a terminal equipment side, with contents identical to those in the embodiments of the first aspect being not going to be described herein any further.

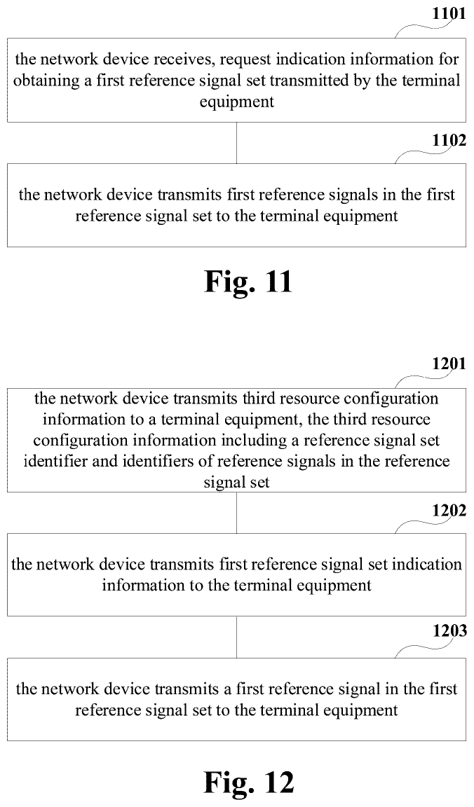

FIG. 11 is a schematic diagram of the information transceiving method of the embodiments of this disclosure. As shown in FIG. 11, the method includes:
1101: the network device receives, request indication information for obtaining a first reference signal set transmitted by the terminal equipment; and
1102: the network device transmits first reference signals in the first reference signal set to the terminal equipment.

It should be noted that FIG. 11 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 11.

In some embodiments, implementations of 1101-1102 corresponds to those of 301-302, and shall not be repeated herein any further.

In some embodiments, reference may be made to the embodiments of the first aspect for implementation of the request indication information, and the network device may further transmit the first resource configuration information and the second resource configuration information to the terminal equipment, and reference may be made to the embodiment of the first aspect for implementation thereof, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

With the above embodiment, the terminal equipment transmits the request indication information for acquiring the part of reference signals to the network device, thereby informing the network device of the information on the part of reference signals used in the stage of inference of the AI model, which may effectively use the AI model to predict the optimal beam pair, and greatly reduce the system payload and latency caused by beam measurement.

The above information transceiving methods between the terminal equipment and the network device in the embodiments of the first and second aspects are as described below.

FIG. 9 is a schematic diagram of the information transceiving method of the embodiments of this disclosure. As shown in FIG. 9, the method includes:
901: the network device transmits the first resource configuration information to the terminal equipment;
902: the network device transmits measurement report configuration information to the terminal equipment;
903: the terminal equipment transmits the request indication information to the network device;
904: the network device transmits the second resource configuration information by to the terminal equipment;
905: the network device transmits the first reference signals in the first reference signal set to the terminal equipment;
906: the terminal equipment performs beam measurement by using the first reference signals;
907: the terminal equipment takes measurement results as input to feed into the AI model to obtain prediction results;
908: the terminal equipment transmits the beam measurement report information to the network device; and
909: the network device transmits downlink data to the terminal equipment.

In some embodiments, reference may be made to 301-302 for implementations of 903 and
905, which shall not be repeated herein any further.

In some embodiments, in 902, parameters needed in configuring the measurement report include: a report quantity, measurement constraint configuration, codebook configuration, group-based report configuration, and a report period, etc. For example, when beam management is needed, the report quantity is a combination of the following parameters: CRI-RSRP/SINR (CSI-RS-based beam management) or SSBRI-RSRP/SINR (SSB-based beam management). In 906, the terminal equipment measures L1-RSRPs or SINRs corresponding to downlink transmitting beam via the first reference signals and takes them as measurement results. In 907, the terminal equipment inputs the measurement result into the AI model to predict and obtain one or some optimal downlink beam pairs. In 908, the terminal equipment transmits the beam measurement report information (carried by UCI) on corresponding time-frequency resources. The report information includes results predicted by the AI model, such as including downlink transmitting beam information of the one or some optimal downlink beam pairs obtained through prediction, and corresponding measurement results. For example, the report information includes measurement results RSRP (reference signal receiving power) values #1, #2, #3, #4, and synchronization signal block (SSB) resource indicators (SSB RIs) or channel state information reference signal (CSI-RS) resource indicators (CRIs) #1, #2, #3, #4 associated with the measurement result RSRP. As the network device side learns a correspondence between the SSB RIs or CRIs and the downlink transmitting beams, one or some optimal downlink transmitting beams obtained through prediction may be implicitly indicated by the SSB RIs or CRIs, so that in 909, the network device transmits the downlink data by using the downlink transmitting beams, and the terminal equipment selects downlink receiving beams corresponding to the downlink transmitting beams to receive the downlink data according to indication information on the downlink transmitting beams in TCI (transmission configuration indicator) signaling.

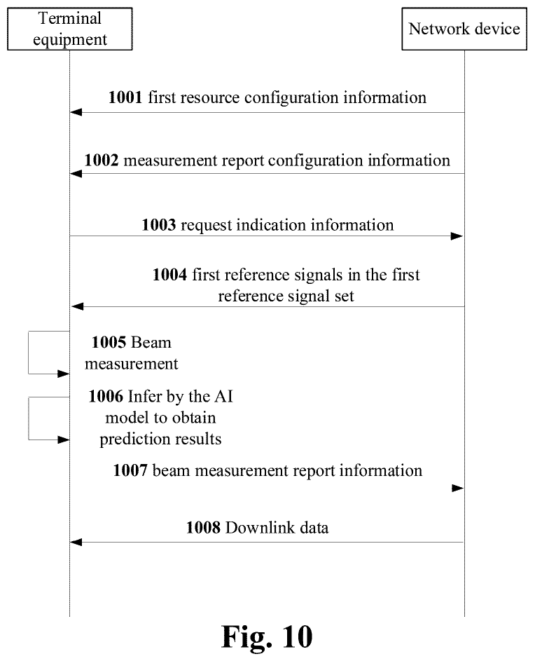

FIG. 10 is a schematic diagram of the information transceiving method of the embodiments of this disclosure. As shown in FIG. 10, the method includes:
1001: the network device transmits the first resource configuration information to the terminal equipment;
1002: the network device transmits the measurement report configuration information to the terminal equipment;
1003: the terminal equipment transmits the request indication information to the network device;
1004: the network device transmits the first reference signals in the first reference signal set to the terminal equipment;
1005: the terminal equipment performs beam measurement by using the first reference signals;
1006: the terminal equipment takes measurement results as input to feed into the AI model to obtain prediction results;
1007: the terminal equipment transmits the beam measurement report information to the network device; and
1008: the network device transmits downlink data to the terminal equipment.

Similarities between FIG. 10 and FIG. 9 shall not be repeated herein any further, and a difference therebetween is that the network device transmits the first reference signals in the first reference signal set directly according to the request indication information, without needing to transmit the second resource configuration information.

### Embodiments of a Third Aspect

The embodiments of this disclosure provide an information transceiving method, which shall be described from a network device side, an AI model being deployed at the network device side.

FIG. 12 is a schematic diagram of the information transceiving method of the embodiments of this disclosure. As shown in FIG. 12, the method includes:
1201: the network device transmits third resource configuration information to a terminal equipment, the third resource configuration information including a reference signal set identifier and identifiers of reference signals in the reference signal set;
1202: the network device transmits first reference signal set indication information to the terminal equipment; and
1203: the network device transmits a first reference signal in the first reference signal set to the terminal equipment.

It should be noted that FIG. 12 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 12.

In some embodiments, an AI model for beam prediction is deployed in the network device, and an optimal beam pair is predicted by using the AI model according to measurement results of a small number of beam pairs. Input parameters of the AI model are RSRP (reference signal receiving power) values of a part of beam pairs, and may also be SINR (signal to interference plus noise ratio) values of a part of beam pairs, and physical quantities of output parameters are RSRP or SINRs of all beam pairs. This model is identical to the AI model shown in FIG. 4, which shall not be repeated herein any further.

That is, in an inference stage of the AI model, the network device only needs to configure a part of reference signals in the reference signal set and transmit them to the terminal equipment via a part of transmitting beams for beam measurement and report. Information reported by the terminal equipment needs to include information on the part of reference signals. Hence, in the embodiments of this disclosure, the network device transmits the first reference signal set indication information to the terminal equipment.

With the above embodiment, the network device transmits the indication information on the part of reference signals to the terminal equipment, thereby informing the terminal equipment of the information on the part of reference signals used in the inference stage of the AI model. Hence, the AI model may be effectively used to predict an optimal beam pair, which may greatly reduce a system payload and latency caused by the beam measurement.

Detailed description shall be given below, in which a reference signal and a measurement resource or a resource are interchangeable.

In some embodiments, the network device configures measurement resources (reference signals) for downlink transmitting beams via third resource configuration information. The measurement resources (reference signals) may be CSI-RSs and/or SSBs, etc., for example, the configured measurement resources are resource set lists (reference signal sets), each resource set consisting of one or more measurement resources (reference signals). In other words, the network device may configure multiple reference signals used for beam measurement for the terminal equipment. The third resource configuration information includes a reference signal set identifier (measurement resource set identifier) and an identifier/identifiers of one or more measurement resources (reference signals) constituting the reference signal set (measurement resource set). reference may be made to the implementation of the first resource configuration information in the embodiments of the first aspect for implementation of the third resource configuration information, which shall not be repeated herein any further.

In some embodiments, in 1202, the network device transmits first reference signal set indication information to the terminal equipment, and reference may be made to the embodiments of the first aspect for a meaning of the first reference signal.

In some embodiments, the first reference signal set indication information includes an identifier of the first reference signal in the first reference signal set, or the first reference signal set indication information indicates the first reference signal set in the configured reference signal set in a manner of a bitmap or a starting position and interval information, or the first reference signal set indication information indicates the activated reference signals in the reference signal set, the activated reference signals being taken as the first reference signals in the first reference signal set. The first reference signal set indication information may be carried by RRC or an MAC CE or UCI.

In some embodiments, the first reference signal set indication information is included or not included in the third resource configuration information. For example, the first reference signal set indication information may be newly-added RRC signaling or MAC CE signaling, and is not included in the third resource configuration information, but is transmitted separately from the third resource configuration information; or, for example, the first reference signal set indication information may be a newly-added information element, included in the third resource configuration information, and is transmitted together with the third resource configuration information; however, the embodiments of this disclosure are not limited thereto.

In some embodiments, when the first reference signal set indication information is newly-added signaling, reference may be made to the second resource configuration information in the embodiments of the first aspect for implementation thereof, which shall not be repeated herein any further. When the first reference signal set indication information is a newly-added information element, included in the third resource configuration information and transmitted together with the third resource configuration information, indication modes thereof further include the following examples, which shall be described below in detail.

In some embodiments, the first reference signal set indication information is a newly-added information element in the third resource configuration information, where the newly-added information element includes identifiers of the first reference signals in the first reference signal set, or indicates the first reference signal set in the configured reference signal set in a manner of a bitmap or a starting position and interval information.

For example, when the reference signals are CSI-RSs, the third resource configuration information may be non-zero power CSI-RS resource set configuration information, and NZP-CSI-RS-ResourceSet may be expressed as follows by using an ASN.1 data format:

-- ASN1START
-- TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-RS- |

ResourcesPerSet)) OF NZP-CSI-RS-ResourceId,

| | |
|---|---|
| nzp-CSI-RS-Resources-subset | BIT STRING (size(maxNrofNZP-CSI-RS- |

ResourcesPerSet))

| | |
|---|---|
| repetition | ENUMERATED { on, off } |

OPTIONAL,

| | |
|---|---|
| aperiodicTriggeringOffset | INTEGER(0..6) |

OPTIONAL,

| | |
|---|---|
| trs-Info | ENUMERATED {true} |

```
OPTIONAL,
    ...,
    [[
```

| | |
|---|---|
| aperiodicTriggeringOffset-r16 | INTEGER(0..31) |

OPTIONAL -
]]
}
-- TAG-NZP-CSI-RS-RESOURCESET-STOP
-- ASN1STOP

That is, a field nzp-CSI-RS-Resources-subset (the first reference signal set indication information) is added to NZP-CSI-RS-ResourceSet (the third resource configuration information). The field is denoted by a bitmap and has a length of maxNrofNZP-CSI-RS-ResourcesPerSet, that each bit value in the bitmap is 0 indicates that a reference signal to which the bit corresponds is not included in the first reference signal set, and that each bit value in the bitmap is 1 indicates that a reference signal to which the bit corresponds is included in the first reference signal set, and vice versa.

For example, when the reference signals are CSI-RSs, the third resource configuration information may be non-zero power CSI-RS resource set configuration information, and NZP-CSI-RS-ResourceSet may be expressed as follows by using an ASN.1 data format:

-- TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-RS- |

ResourcesPerSet)) OF NZP-CSI-RS-ResourceId,

| | |
|---|---|
| nzp-CSI-RS-Resources-subset | SEQUENCE { |
| offset | INTEGER(0.. maxNrofNZP-CSI-RS-ResourcesPerSet-1) |
| interval | INTEGER(1.. maxNrofNZP-CSI-RS-ResourcesPerSet-1) |
| } | |
| repetition | ENUMERATED { on, off } |
| OPTIONAL, | |
| aperiodicTriggeringOffset | INTEGER(0..6) |
| OPTIONAL, | |
| trs-Info | ENUMERATED {true} |
| OPTIONAL, | |
| ..., | |
| [[ | |
| aperiodicTriggeringOffset-r16 | INTEGER(0..31) |

OPTIONAL -
]]
}
-- TAG-NZP-CSI-RS-RESOURCESET-STOP
-- ASN1STOP

That is, a field nzp-CSI-RS-Resources-subset (the first reference signal set indication information) is added to NZP-CSI-RS-ResourceSet (the third resource configuration information), and includes two fields, a starting position offset and interval information interval, which are used to indicate a starting position and interval of an index of a first reference signal of the first reference signal set in the reference signal set, wherein the offset field and interval field are integers, and ranges thereof are determined according to maxNrofNZP-CSI-RS-ResourcesPerSet. It should be noted here that data types of the offset and interval are defined by using continuous integers, and other data types may also be adopted, such as enumeration, and the embodiments of this disclosure are not limited thereto.

For example, when the reference signals are SSBs, the third resource configuration information may be CSI-SSB-ResourceSet, and may be expressed as follows by using an ASN.1 data format:

-- ASN1START
-- TAG-CSI-SSB-RESOURCESET-START

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB-ResourcePerSet)) |
| OF SSB-Index, | |
| csi-SSB-Resources-subset | BIT STRING (size(maxNrofCSI-SSB-ResourcePerSet)) |

...
}
-- TAG-CSI-SSB-RESOURCESET-STOP
-- ASN1STOP

That is, a field CSI-SSB-Resources-subset (the first reference signal set indication information) is added to CSI-SSB-ResourceSet (the third resource configuration information). The field is denoted by a bitmap and has a length of maxNrofCSI-SSB-ResourcesPerSet, that each bit value in the bitmap is 0 indicates that a reference signal to which the bit corresponds is not included in the first reference signal set, and that each bit value in the bitmap is 1 indicates that a reference signal to which the bit corresponds is included in the first reference signal set, and vice versa.

For example, when the reference signals are SSBs, the third resource configuration information may be CSI-SSB-ResourceSet, and may be expressed as follows by using an ASN.1 data format:

-- ASN1START
-- TAG-CSI-SSB-RESOURCESET-START

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB-ResourcePerSet)) |
| OF SSB-Index, | |
| csi-SSB-Resources-subset | SEQUENCE { |
| offset | INTEGER(0.. maxNrofCSI-SSB-ResourcePerSet -1) |
| interval | INTEGER(1.. maxNrofCSI-SSB-ResourcePerSet -1) |

```
  }
    ...
}
-- TAG-CSI-SSB-RESOURCESET-STOP
-- ASN1STOP
```

That is, a field CSI-SSB-Resources-subset (the first reference signal set indication information) is added to CSI-SSB-ResourceSet (the third resource configuration information), and includes two fields, a starting position offset and interval information interval, which are used to indicate a starting position and interval of an index of a first reference signal of the first reference signal set in the reference signal set, wherein the offset field and interval field are integers, and ranges thereof are determined according to maxCSI-SSB-ResourcesPerSet. It should be noted here that data types of the offset and interval are defined by using continuous integers, and other data types may also be adopted, such as enumeration, and the embodiments of this disclosure are not limited thereto.

In the above embodiment (the newly-added information element), when the third resource configuration information includes the first reference signal set indication information, it indicates that the information of the first reference signal set needs to be configured, such as a scenario where an AI model is deployed is applied; and when the third resource configuration information does not include the first reference signal set indication information, it indicates that the information of the first reference signal set does not need to be configured, such as a scenario where no AI model is deployed is applied.

In some embodiments, in 1203, the network device transmits the first reference signals on the downlink channels based on the first reference signal set indication information. That is, the terminal equipment receives corresponding first reference signals on corresponding time-frequency resources according to mapped time-frequency resources, and periods, etc., of the first reference signals, and performs beam measurement on the first reference signals in the first reference signal set, and the network device receives results of the beam measurement performed on the first reference signals in the first reference signal set reported by the terminal equipment, the results of the beam measurement being used for inference of the AI model.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

With the above embodiment, the network device transmits the indication information on the part of reference signals to the terminal equipment, thereby informing the terminal equipment of the information on the part of reference signals used in the inference stage of the AI model. Hence, the AI model may be effectively used to predict an optimal beam pair, which may greatly reduce a system payload and latency caused by the beam measurement.

### Embodiments of a Fourth Aspect

The embodiments of this disclosure provide an information transceiving method, which shall be described from a network device side, an AI model being deployed at a network device side, with contents identical to those in the embodiments of the third aspect being not going to be described herein any further.

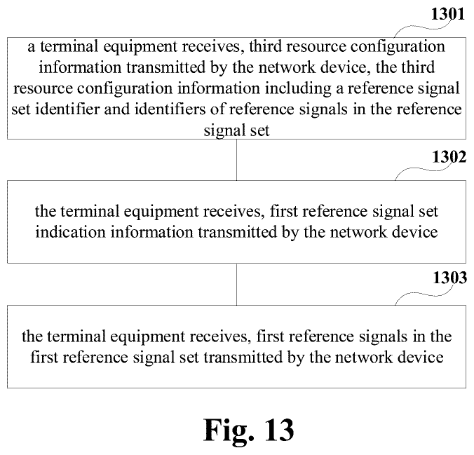

FIG. 13 is a schematic diagram of the information transceiving method of the embodiments of this disclosure. As shown in FIG. 13, the method includes:
1301: a terminal equipment receives, third resource configuration information transmitted by the network device, the third resource configuration information including a reference signal set identifier and identifiers of reference signals in the reference signal set;
1302: the terminal equipment receives, first reference signal set indication information transmitted by the network device; and
1303: the terminal equipment receives, first reference signals in the first reference signal set transmitted by the network device.

It should be noted that FIG. 13 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 13.

In some embodiments, implementations of 1301-1302 corresponds to those of 1201-1202, and shall not be repeated herein any further.

In some embodiments, reference may be made to the embodiments of the third aspect for implementation of the first reference signal set indication information, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

With the above embodiment, the network device transmits the indication information of the part of reference signals to the terminal equipment, thereby informing the terminal equipment of the information on the part of reference signals used in the stage of inference of the AI model, which may effectively use the AI model to predict the optimal beam pair, and greatly reduce the system payload and latency caused by beam measurement.

The above information transceiving methods between the terminal equipment and the network device in the embodiments of the third and fourth aspects are as described below.

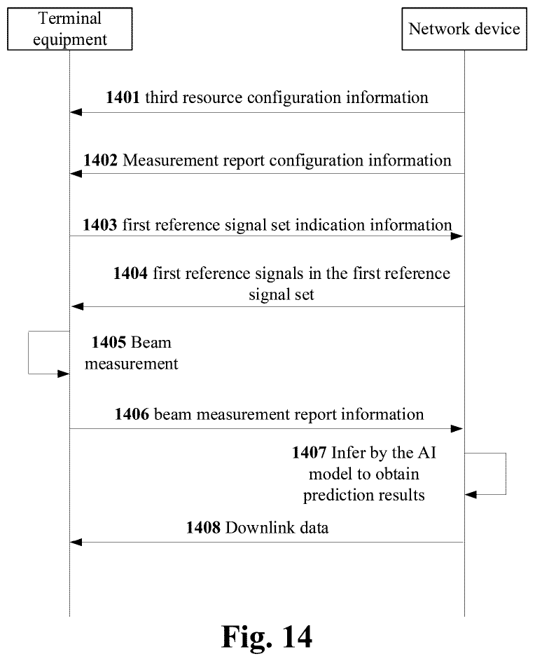

FIG. 14 is a schematic diagram of the information transceiving method of the embodiments of this disclosure. As shown in FIG. 14, the method includes:
1401: the network device transmits the third resource configuration information to the terminal equipment;
1402: the network device transmits measurement report configuration information to the terminal equipment;
1403: the network device transmits the first reference signal set indication information (configuring the first reference signals or activating the first reference signals) to the terminal equipment;
1404: the network device transmits the first reference signals in the first reference signal set to the terminal equipment;
1405: the network device performs beam measurement by using the first reference signals;
1406: the terminal equipment transmits the beam measurement report information to the network device;
1407: the network device takes measurement results as input to feed into the AI model to obtain prediction results; and
1408: the network device transmits downlink data to the terminal equipment.

A difference from the implementation in FIG. 9 is that as the AI model is deployed at the network device side, the network device may select the first reference signals as demanded by the AI model, without the need for the terminal equipment to inform the first reference signals via request indication information, and the network device transmits the first reference signal set indication information to the terminal equipment. In addition, as the AI model is deployed at the network device side, in 1407-1408, output of the AI model is results of prediction of all beam pairs, and an optimal downlink transmitting beam may be selected from the results of prediction. The network device uses the optimal downlink transmitting beam to transmit the downlink data.

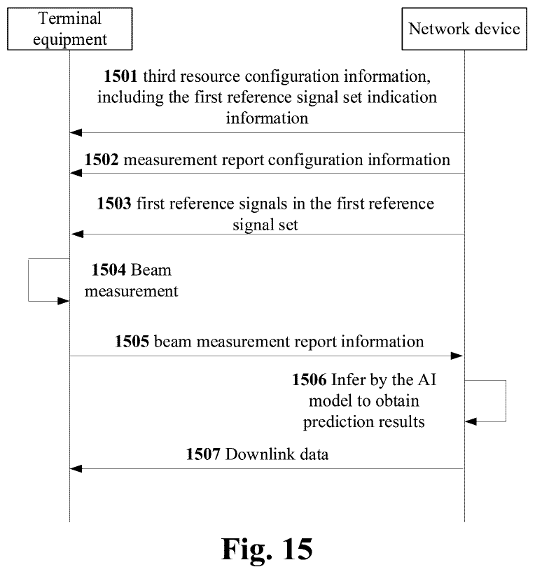

FIG. 15 is a schematic diagram of the information transceiving method of the embodiments of this disclosure. As shown in FIG. 15, the method includes:
1501: the network device transmits the third resource configuration information (including the first reference signal set indication information) to the terminal equipment;
1502: the network device transmits the measurement report configuration information to the terminal equipment;
1503: the network device transmits the first reference signals in the first reference signal set to the terminal equipment;
1504: the terminal equipment performs beam measurement by using the first reference signals;
1505: the terminal equipment transmits the beam measurement report information to the network device;
1506: the network device takes measurement results as input to feed into the AI model to obtain prediction results; and
1507: the network device transmits downlink data to the terminal equipment.

Similarities between FIG. 15 and FIG. 14 shall not be repeated herein any further, and a difference therebetween is that the network device includes the first reference signal set indication information in the third resource configuration information and transmits.

### Embodiments of a Fifth Aspect

The embodiments of this disclosure provide an information transceiving apparatus. The apparatus may be, for example, a terminal equipment, or one or some components or assemblies configured in the terminal equipment. Contents in this embodiment identical to those in the embodiments of the first or the fourth aspect shall not be described herein any further.

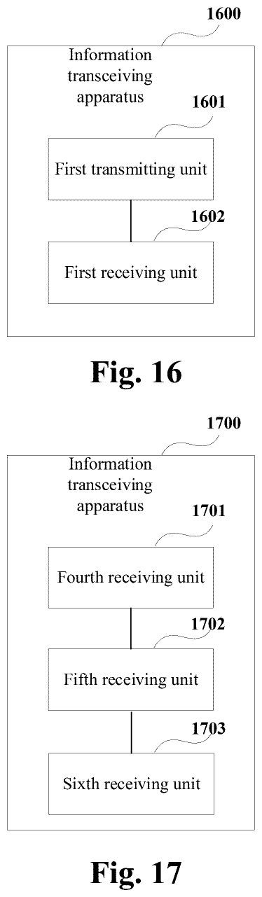

FIG. 16 is a schematic diagram of the information transceiving apparatus of the embodiments of this disclosure. As shown in FIG. 16, an information transceiving apparatus 1600 includes:
a first transmitting unit 1601 configured to transmit request indication information for acquiring a first reference signal set to a network device; and
a first receiving unit 1602 configured to receive a first reference signal in the first reference signal set transmitted by the network device.

Reference may be made the embodiments of the first aspect for implementations of the first transmitting unit 1601 and the first receiving unit 1602, and reference may be made the embodiments of the first aspect for implementation of the request indication information. The first receiving unit is further configured to receive first resource configuration information and second resource configuration information, and reference may be made the embodiments of the first aspect for implementation thereof, which shall not be described herein any further.

In some embodiments, the apparatus may further include:
a first processing unit (not shown) configured to perform beam measurement on the first reference signals in the first reference signal set, a result of the beam measurement being used for inference of the AI model.

FIG. 17 is a schematic diagram of the information transceiving apparatus of the embodiments of this disclosure. As shown in FIG. 17, an information transceiving apparatus 1700 includes:
a fourth receiving unit 1701 configured to receive third resource configuration information transmitted by a network device, the third resource configuration information including a reference signal set identifier and identifiers of reference signals in the reference signal set;
a fifth receiving unit 1702 configured to receive first reference signal set indication information transmitted by the network device; and
a sixth receiving unit 1703 configured to receive a first reference signal in the first reference signal set transmitted by the network device.

Reference may be made the embodiments of the fourth aspect for implementations of the fourth receiving unit 1701, the fifth receiving unit 1702 and the sixth receiving unit 1703, and reference may be made the embodiments of the third aspect for implementations of the third resource configuration information and the first reference signal set indication information, which shall not be described herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information transceiving apparatus 1600 or 1700 may further include other components or modules, and reference may be made to related techniques for particulars of these components or modules.

Furthermore, for the sake of simplicity, connection relationships between the components or modules or signal profiles thereof are only illustrated in FIGS. 16 and 17. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

### Embodiments of a Sixth Aspect

The embodiments of this disclosure provide an information transceiving apparatus. The apparatus may be, for example, a network device, or one or some components or assemblies configured in the network device. Contents in this embodiment identical to those in the embodiments of the second or the third aspect shall not be described herein any further.

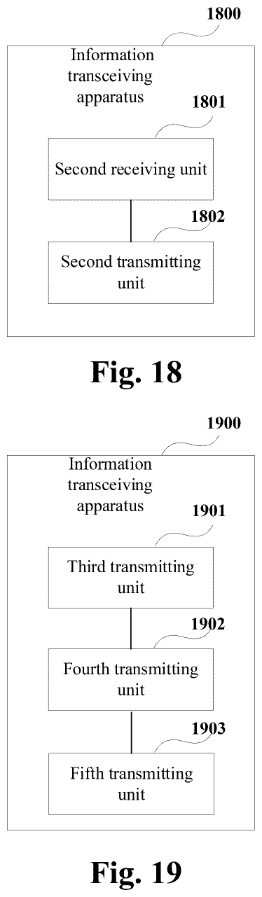

FIG. 18 is a schematic diagram of the information transceiving apparatus of the embodiments of this disclosure. As shown in FIG. 18, an information transceiving apparatus 1800 includes: a second receiving unit 1801 configured to receive request indication information transmitted by a terminal equipment for acquiring a first reference signal set; and a second transmitting unit 1802 configured to transmit a first reference signal in the first reference signal set to the terminal equipment.

Reference may be made the embodiments of the second aspect for implementations of the second receiving unit 1801 and the second transmitting unit 1802, and reference may be made the embodiments of the first aspect for implementation of the request indication information. The second transmitting unit is further configured to transmit first resource configuration information and second resource configuration information, and reference may be made the embodiments of the first aspect for implementation thereof, which shall not be described herein any further.

FIG. 19 is a schematic diagram of the information transceiving apparatus of the embodiments of this disclosure. As shown in FIG. 19, an information transceiving apparatus 1900 includes:
a third transmitting unit 1901 configured to transmit third resource configuration information to a terminal equipment, the third resource configuration information including a reference signal set identifier and identifiers of reference signals in the reference signal set;
a fourth transmitting unit 1902 configured to transmit first reference signal set indication information to the terminal equipment; and
a fifth transmitting unit 1903 configured to transmit a first reference signal in the first reference signal set to the terminal equipment.

Reference may be made the embodiments of the third aspect for implementations of the third transmitting unit 1901, the fourth transmitting unit 1902 and the fifth transmitting unit 1903, and reference may be made the embodiments of the third aspect for implementations of the third resource configuration information and the first reference signal set indication information, which shall not be described herein any further.

The apparatus may further include: a third receiving unit (not shown) configured to receive a measurement result of beam measurement performed on the first reference signal in the first reference signal set reported by the terminal equipment, the measurement result being used for inference of the AI model.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information transceiving apparatus 1800 or 1900 may further include other components or modules, and reference may be made to related techniques for particulars of these components or modules.

Furthermore, for the sake of simplicity, connection relationships between the components or modules or signal profiles thereof are only illustrated in FIGS. 18 and 19. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

### Embodiments of a Seventh Aspect

The embodiments of this disclosure provide a communication system, and reference may be made to FIG. 1, with contents identical to those in the embodiments of the first to the fourth aspects being not going to be described herein any further.

In some embodiments, the communication system 100 may at least include a network device 101 and/or a terminal equipment 102, the network device 101 including the information transceiving apparatus 1800 or 1900 in the embodiments of the sixth aspect, and the terminal equipment 102 including the information transceiving apparatus 1600 or 1700 in the embodiments of the fifth aspect, which shall not be repeated herein any further.

The embodiments of this disclosure further provide a network device, which may be, for example, a base station. However, this disclosure is not limited thereto, and it may also be another network device.

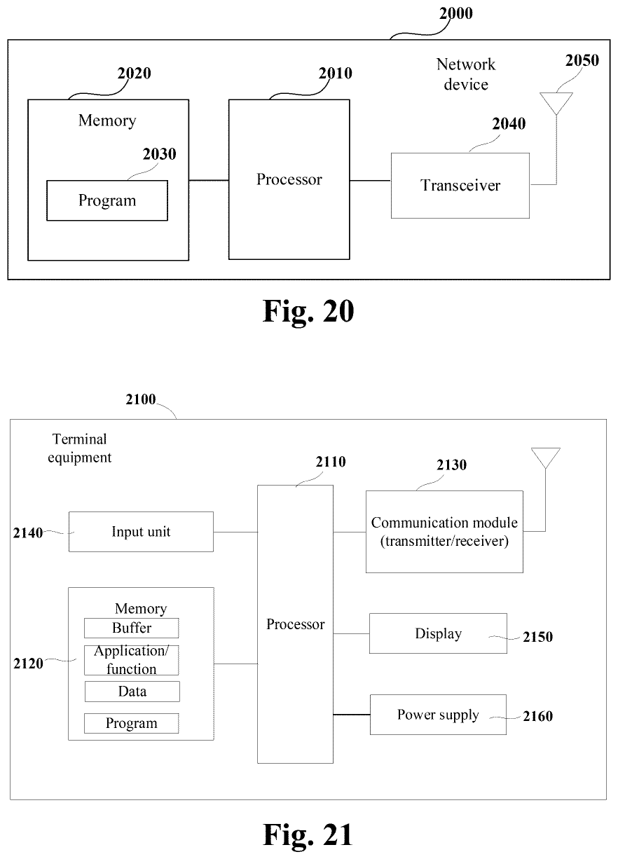

FIG. 20 is a schematic diagram of a structure of the network device of the embodiments of this disclosure. As shown in FIG. 20, the network device 2000 may include a processor 2010 (such as a central processing unit (CPU)) and a memory 2020, the memory 2020 being coupled to the processor 2010. The memory 2020 may store various data, and furthermore, it may store a program 2030 for information processing, and execute the program 2030 under control of the processor 2010.

For example, the processor 2010 may be configured to execute a program to carry out the information transceiving method described in the embodiments of the second or the third aspect.

Furthermore, as shown in FIG. 20, the network device 2000 may include a transceiver 2040, and an antenna 2050, etc. Functions of the above components are similar to those in the related art, and shall not be described herein any further. It should be noted that the network device 2000 does not necessarily include all the parts shown in FIG. 20, and furthermore, the network device 2000 may include parts not shown in FIG. 20, and the related art may be referred to.

The embodiments of this disclosure further provide a terminal equipment; however, this disclosure is not limited thereto, and it may also be another equipment.

FIG. 21 is a schematic diagram of the terminal equipment of the embodiments of this disclosure. As shown in FIG. 21, a terminal equipment 2100 may include a processor 2110 and a memory 2120, the memory 2120 storing data and a program and being coupled to the processor 2110. It should be noted that this figure is illustrative only, and other types of structures may also be used, so as to supplement or replace this structure and achieve a telecommunications function or other functions.

For example, the processor 2110 may be configured to execute a program to carry out the information transceiving method as described in the embodiments of the first or the fourth aspect. As shown in FIG. 21, the terminal equipment 2100 may further include a communication module 2130, an input unit 2140, a display 2150, and a power supply 2160, wherein functions of the above components are similar to those in the related art, which shall not be described herein any further. It should be noted that the terminal equipment 2100 does not necessarily include all the parts shown in FIG. 21, and the above components are not necessary. Furthermore, the terminal equipment 2100 may include parts not shown in FIG. 21, and the related art may be referred to.

Embodiments of this disclosure provide a computer readable program, which, when executed in a terminal equipment, causes the terminal equipment to carry out the information transceiving method as described in the embodiments of the first aspect or the fourth aspect.

Embodiments of this disclosure provide a computer storage medium, including a computer readable program, which causes a terminal equipment to carry out the information transceiving method as described in the embodiments of the first aspect or the fourth aspect.

Embodiments of this disclosure provide a computer readable program, which, when executed in a network device, causes the network device to carry out the information transceiving method as described in the embodiments of the second aspect or the third aspect.

Embodiments of this disclosure provide a computer storage medium, including a computer readable program, which causes a network device to carry out the information transceiving method as described in the embodiments of the second aspect or the third aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.

1. An information transceiving method, application to a terminal equipment, characterized in that the method includes:
transmitting request indication information for acquiring a first reference signal set by the terminal equipment to a network device; and
receiving, by the terminal equipment, a first reference signal in the first reference signal set transmitted by the network device.

2. The method according to supplement 1, wherein, the terminal equipment is further configured to receive first resource configuration information transmitted by the network device, the first resource configuration information including a reference signal set identifier and identifiers of reference signals in the reference signal set.

3. The method according to supplement 1 or 2, wherein, the terminal equipment is further configured to, before receiving the first reference signal in the first reference signal set, receive second resource configuration information transmitted by the network device, the second resource configuration information including identification indication information of the first reference signal in the first reference signal set.

4. The method according to any one of supplements 1-3, wherein the first reference signal in the first reference signal set indicated by the request indication information is one or more reference signals in the reference signal set.

5. The method according to any one of supplements 1-4, wherein the request indication information includes an identifier of the first reference signal in the first reference signal set, or the request indication information indicates the first reference signal set in configured reference signal set in a manner of bitmap or a starting position and interval information.

6. The method according to supplement 5, wherein the identifier of the first reference signal in the first reference signal set is a CRI or SSB-RI.

7. The method according to supplement 5, wherein the request indication information further includes a reference signal set identifier.

8. The method according to any one of supplements 1-7, wherein an AI model is deployed at the terminal equipment side.

9. The method according to any one of supplements 1-8, wherein the method further includes: performing beam measurement by the terminal equipment on the first reference signal in the first reference signal set, a result of the beam measurement being used for inference of the AI model.

10. The method according to any one of supplements 1-9, wherein the request indication information is carried by RRC or an MAC CE or UCI.

11. An information transceiving method, application to a network device, characterized in that the method includes:
transmitting third resource configuration information by the network device to a terminal equipment, the third resource configuration information including a reference signal set identifier and identifiers of reference signals in the reference signal set;
transmitting first reference signal set indication information by the network device to the terminal equipment; and
transmitting a first reference signal in the first reference signal set by the network device to the terminal equipment.

12. The method according to supplement 11, wherein the first reference signal in the first reference signal set indicated by the first reference signal set indication information is one or more reference signals in the reference signal set.

13. The method according to supplement 11 or 12, wherein the first reference signal set indication information is carried by RRC or an MAC CE or DCI.

14. The method according to supplement 13, wherein the first reference signal set indication information is contained in the third resource configuration information or is not contained in the third resource configuration information.

15. The method according to any one of supplements 11-14, wherein the first reference signal set indication information includes an identifier of the first reference signal in the first reference signal set, or the first reference signal set indication information indicates the first reference signal set in configured reference signal set in a manner of bitmap or a starting position and interval information, or the first reference signal set indication information indicates an activated reference signal in the reference signal set, the activated reference signal being taken as the first reference signal in the first reference signal set.

16. The method according to supplement 15, wherein the identifier of the first reference signal in the first reference signal set is a CRI or SSB-RI.

17. The method according to any one of supplements 11-16, wherein the first reference signal set indication information further includes a reference signal set identifier.

18. The method according to any one of supplements 11-17, wherein an AI model is deployed at the network device side.

19. The method according to any one of supplements 11-18, wherein the method further includes:

receiving, by the network device, a measurement result of beam measurement performed on the first reference signal in the first reference signal set reported by the terminal equipment, the measurement result being used for inference of the AI model.

20. An information transceiving method, applicable to a network device, characterized in that the method includes:
receiving, by the network device, request indication information transmitted by a terminal equipment for acquiring a first reference signal set; and
transmitting a first reference signal in the first reference signal set by the network device to the terminal equipment.

21. The method according to supplement 20, wherein the method further includes:
transmitting first resource configuration information by the network device to the terminal equipment, the first resource configuration information including a reference signal set identifier and identifiers of reference signals in the reference signal set.

22. The method according to supplement 20 or 21, wherein the method further includes: transmitting second resource configuration information by the network device to the terminal equipment, the second resource configuration information including identifier of the first reference signal in the first reference signal set.

23. An information transceiving method, application to a terminal equipment, characterized in that the method includes:
receiving, by the terminal equipment, third resource configuration information transmitted by a network device, the third resource configuration information including a reference signal set identifier and identifiers of reference signals in the reference signal set;
receiving, by the terminal equipment, first reference signal set indication information transmitted by the network device; and
receiving, by the terminal equipment, a first reference signal in the first reference signal set transmitted by the network device.

24. An information transceiving apparatus, application to a terminal equipment, characterized in that the apparatus includes:
a fourth receiving unit configured to receive third resource configuration information transmitted by a network device, the third resource configuration information including a reference signal set identifier and identifiers of reference signals in the reference signal set;
a fifth receiving unit configured to receive first reference signal set indication information transmitted by the network device; and
a sixth receiving unit configured to receive a first reference signal in the first reference signal set transmitted by the network device.

25. A network device, including a memory and a processor, the memory storing a computer program, and the processor being configured to execute the computer program to carry out the method as described in any one of supplements 11-23.

26. A terminal equipment, including a memory and a processor, the memory storing a computer program, and the processor being configured to execute the computer program to carry out the method as described in any one of supplements 1-10 and 23.

27. A communication system, including the network device as described in supplement 25 and/or the terminal equipment as described in supplement 26.

What is claimed is:

1. An information transceiving apparatus, applicable to a terminal equipment, characterized in that the apparatus comprises:
a first transmitting unit configured to transmit request indication information for acquiring a first reference signal set to a network device; and
a first receiving unit configured to receive a first reference signal in the first reference signal set transmitted by the network device.

2. The apparatus according to claim 1, wherein,
the first receiving unit is further configured to receive first resource configuration information transmitted by the network device, the first resource configuration information comprising a reference signal set identifier and identifiers of reference signals in the reference signal set.

3. The apparatus according to claim 1, wherein,
the first receiving unit is further configured to, before receiving the first reference signal in the first reference signal set, receive second resource configuration information transmitted by the network device, the second resource configuration information comprising identification indication information of the first reference signal in the first reference signal set.

4. The apparatus according to claim 1, wherein the first reference signal in the first reference signal set indicated by the request indication information is one or more reference signals in the reference signal set.

5. The apparatus according to claim 1, wherein the request indication an identifier of the first reference signal in the first reference signal set, or the request indication information indicates the first reference signal set in configured reference signal set in a manner of bitmap or a starting position and interval information.

6. The apparatus according to claim 5, wherein the identifier of the first reference signal in the first reference signal set is a CRI or SSB-RI.

7. The apparatus according to claim 5, wherein the request indication information further comprises a reference signal set identifier.

8. The apparatus according to claim 1, wherein an AI model is deployed at the terminal equipment side.

9. The apparatus according to claim 1, wherein the apparatus further comprises:
a first processing unit configured to perform beam measurement on the first reference signal in the first reference signal set, a result of the beam measurement being used for inference of the AI model.

10. The apparatus according to claim 1, wherein the request indication information is carried by RRC or an MAC CE or UCI.

11. An information transceiving apparatus, applicable to a network device, characterized in that the apparatus comprises:
a third transmitting unit configured to transmit third resource configuration information to a terminal equipment, the third resource configuration information comprising a reference signal set identifier and identifiers of reference signals in the reference signal set;
a fourth transmitting unit configured to transmit first reference signal set indication information comprises
information to the terminal equipment; and
a fifth transmitting unit configured to transmit a first reference signal in the first reference signal set to the terminal equipment.

12. The apparatus according to claim 11, wherein the first reference signal in the first reference signal set indicated by the first reference signal set indication information is one or more reference signals in the reference signal set.

13. The apparatus according to claim 11, wherein the first reference signal set indication information is carried by RRC or an MAC CE or DCI.

14. The apparatus according to claim 13, wherein the first reference signal set indication information is contained in the third resource configuration information or is not contained in the third resource configuration information.

15. The apparatus according to claim 11, wherein the first reference signal set indication information comprises an identifier of the first reference signal in the first reference signal set, or the first reference signal set indication information indicates the first reference signal set in configured reference signal set in a manner of bitmap or a starting position and interval information, or the first reference signal set indication information indicates an activated reference signal in the reference signal set, the activated reference signal being taken as the first reference signal in the first reference signal set.

16. The apparatus according to claim 15, wherein the identifier of the first reference signal in the first reference signal set is a CRI or SSB-RI.

17. The apparatus according to claim 11, information further comprises a reference signal set identifier.

18. The apparatus according to claim 11, wherein an AI model is deployed at the network device side.

19. The apparatus according to claim 11, wherein the apparatus further comprises:
a third receiving unit configured to receive a measurement result of beam measurement performed on the first reference signal in the first reference signal set reported by the terminal equipment, the measurement result being used for inference of the AI model.

20. An information transceiving apparatus, applicable to a network device, characterized in that the apparatus comprises:
a second receiving unit configured to receive request indication information transmitted by a terminal equipment for acquiring a first reference signal set; and
a second transmitting unit configured to transmit a first reference signal in the first reference signal set to the terminal equipment.
